(19) United States
(12) Patent Application Publication
(10) Pub. No.: US 2008/0313811 A1
(43) Pub. Date: Dec. 25, 2008

(54) BED FOR ALLOWING POSTURE FOR SITTING ON CHAIR TO BE TAKEN

(76) Inventor: Kyozo Nomura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/767,777

(22) Filed: Jun. 25, 2007

(51) Int. Cl. A61G 7/015

(52) U.S. Cl. 5/613; 5/618

(57) ABSTRACT

The invention provides a bed on which a patient and so forth can take a posture for sitting on a chair, in particular, a bed for allowing the posture for sitting on a chair to be taken, effectively usable even by those having the back in the shape of the round back, Kyphosis or the like.

### FIELD OF THE INVENTION

The invention relates to a bed on which the elderly in need of care, or a patient, and other users (hereinafter referred to simply as patients, and so forth) can take a posture for sitting on a chair, and in particular, to a bed for allowing the posture for sitting on a chair to be taken, usable even by those having the back in the shape of a round back, Kyphosis, or the like.

### BACKGROUND OF THE INVENTION

As disclosed in, for example, JP 0919463-A, in the case of a conventional bed with a knee-lifting function, a mattress is folded up and down in succession, and with the popliteal part of a human body, kept at the apex of the body, the mattress is then tilted toward the sacral region, and the femoral region, whereupon a back rest floor section of the bed is erected, thereby enabling a sitting posture with the legs extended to be taken.

In the case of such a bed in a hospital and so forth, it is undesirable for the patients, and so forth to lie in bed all day long, and there has since been conceived the idea of using a bed on which the patients, and so forth are able to take the sitting posture with the legs extended by erecting the back rest floor section of the bed in order to meet a request for obtaining the sitting posture with the legs extended during the day, and there has already been manufactured a bed with a knee-lifting function, capable of attaining the sitting posture with the legs extended for relatively many hours by lifting knees in succession to, or in parallel with an operation described as above.

Now, there is described hereinafter a mechanism of the lower half of a human body 10. In general, if the body is bent forward with the legs extended, this will cause the backs of the knees to be stretched as shown in FIG. 1, which is largely attributable to stretching of the so-called hamstrings 13, each being one of the tendons at the respective backs of the knees. The hamstrings 13 refer to the biceps muscle 14 of thigh, semitendinous muscle 15, and semimembraneous muscle 16, as shown in FIG. 2, most of those muscles being attached to bones, starting from the ischial bone of the pelvis to the leg bone (the shin bone) below each of the knees. In this case, the hamstring 13 is classified as the so-called double joint muscle as the hamstrings 13 spread across the hip joint, and the knee joint.

When the biceps muscle 14 of thigh, the semitendinous muscle 15, and the semimembraneous muscle 16 are contracted, motions of “bending the knees”, and “kicking up the hip joint backward” will occur. That is, if a movement reverse to such motions is made, the hamstrings 13 are extended. More specifically, motions of “extending the knees”, and “bending the hip joint forward” will occur. That is, as shown in FIG. 3, this will result in “a sitting posture with the legs thrown forward, namely, the sitting posture with the legs extended, and if a movement of bending the trunk of the body forward is made with the posture kept as it is, strain as much as to cause a pain in the back of the knees is felt. Then, “bending the knees” results in slacking of the hamstrings 13, so that upon lifting the back as in the movement of bending the trunk of the body forward, a function for bending the knees becomes effective as in the case of the bed with the knee-lifting function.

In the case of the physically unimpaired, the hamstrings 13 will be stretched as much as a pain is felt only upon bending the trunk forward with the legs thrown forward. Further, when the bed with the knee-lifting function is used by common patients internally treated, or common surgery patients, this type of bed has been found very effective from the viewpoint of diversion of mind, and so forth.

It has been found, however, that in the case of the aged and the like, having the body differing from the standard body, since there has occurred decline in flexibility, and so forth of bones and muscles in various parts of their bodies, the bed with the knee-lifting function, as it is, cannot be used.

More specifically, with a patient who is the elderly in need of care, having bodily functions impaired to the extent of requiring use of a bed for giving nursing care, even when the back rest floor section of the bed is slightly raised to lift the back of the patient, slack in the hamstrings at the respective backs of the knees is lost, so that the more the back rest floor section is raised, the more the knees will be bent. At this point in time, the knees will be bent in such a way as to cause the heels of the feet to be pressed down to the bed. On the other hand, the upper half of the body will be prone to slip down toward the lower part of the body as the bed is more tilted. Accordingly, when the back rest floor section is raised, and the back of the body is lifted, the knees are bent, and the body keeps slipping down centering around the heels of the legs as if pulled by the upper half of the body.

When the body is caused to slip down toward the lower part of the body as described, the pelvis undergoes backward tilt, thereby rendering the spine to be more prone to cause the round back. Accordingly, the greater a degree to which the back rest floor section is raised, the more pronounced such a tendency turns out. Further, the weight of the body comes to be pressed down onto the sacral region of the body instead of the same resting on the tuber of ischium. It is anticipated that continuation in repeated use of the bed in such a way as described will rather cause the round back to occur to the elderly and the like who have the body differing from the standard body.

Further, with the knees in as-lifted state such that the popliteal parts of knees is lifted upward from the apex of the body, on the bed with the knee-lifting function, so as to ease the knees, the knees become unstable, so that the knees are likely to fall on either side of the bed, thereby causing the lower part of the trunk to be twisted, and resulting in occurrence of deformation, around the waist of the aged, and so forth, which is undesirable.

Further, it is said that the round back (FIG. 4), and Kyphosis (FIG. 5), often observed with the elderly, are related to postures taken in daily life, use of a special type bed, aging of bones, decrease in water content of the cartilage, and genes. It is regarded that patients with the round back are unable to take the sitting posture due to degeneration on aging, and they are able to take only a lateral recumbent posture. This is because if the patients with the round back takes the sitting posture, this will cause clearance to emerge in the neighborhood of the back rest floor section, a seat floor section, and an axle of the bed, respectively, and as the pelvis is tilted, the body weight does not rest on the tuber of ischium, but comes to rest on the sacral region of the body, and upon the sacral region being pressed down, there occurs bedsore, thereby causing the body to slip down forward even when the sitting position is taken. As a result, the body weight is not transferred from the spine to the pelvis, and the pelvis falls down into the clearance, thereby causing further development in the round back. For the same reason, the elderly cannot take a supine posture during asleep, so that only a lateral recumbent posture is taken, thereby imposing limitations on selection of body postures. Furthermore, if the elderly falls in a state requiring nursing care, a disuse syndrome will develop, so that the hamstrings undergo contraction, and the knees undergo bending contracture, resulting in difficulty even with walking.

Thus, a bed for allowing a posture for sitting on a chair to be taken, particularly effective for use by those having the back in the shape of the round back, Kyphosis or the like has been practically non-existent.

With the use of the technology as disclosed in JP 10263016-A, there is a possibility of those having the back in the shape of the round back, Kyphosis or the like being able to take the posture for sitting on a chair.

The technology described as above is a technology intended to keep a line of sight horizontally, or to keep the line of sight not higher than a horizontal level for many hours when a bed for nursing care is used, and a seat plate thereof is tilted around the waist of a user's body, in the longitudinal direction of the bed, however, as the back of the body is supported by a back-support band through the intermediary of a flexible mattress, the mattress comes to be configured so as to follow along a curve of the back of the body, so that even a patient having the round back is able to use the bed.

Those having the back in the shape of the round back, Kyphosis or the like can make use of the technology disclosed in JP 10263016-A, however, if use is made of the technology as it is, there is a possibility of occurrence of inconveniences described as follows.

There is a possibility that inconveniences similar to those experienced when a sling sheet is used in a wheel chair can occur to the back-support band. More specifically, it will cause the user to remain in as caving-in state, resulting in a faulty posture if the trunk of the body is out of place. And, as the mattress is flexible, the user will end up in a further caving-in posture. Consequently, if those having the back in the shape of the round back, Kyphosis or the like take the posture for sitting on a chair with the use of the technology described as above, it is possible to cause further development in the shape of the round back, Kyphosis or the like.

More specifically, ratios of weights of the respective parts of a human body to the body weight in the supine posture turn out to be the head:the pectoral:the buttocks:the legs=7:33:44:16 albeit racial and personal differences (Training Text for Advisers Specialized in Equipment for the Handicapped, p. 115, published by Central Registration Publishing Co., Ltd., Nov. 11, 2000). Accordingly, a support band of the femoral region is warped, and further, the femoral region undergoes adduction contracture, resulting in inability to spread the legs apart. Then, the head, the pectoral, and the buttocks, in a sitting position, come to be supported by the support band of the femoral region, and the tuber of ischium. It follows according to the ratios of the weights of the respective parts to the body weight that 84% of the body weight is supported by the support band of the femoral region, and the tuber of ischium. As a result, there is a good possibility that the tuber of ischium irregularly caves in to thereby cause degeneration to occur to the human body although individual conditions of care-receivers differ from each other, and as a seat floor section is fixed horizontally, and a fee-lifting linkage axle is at a position of the femoral region of the human body, the higher the fee-lifting linkage axle is raised, the more the human body is pulled toward the legs because the seat floor section lies flat, so that the pelvis is tilted, and it becomes impossible to cause the tuber of ischium to support the body.

### SUMMARY OF THE INVENTION

It is therefore an object of the invention to provide a bed on which a patient and so forth can take a posture for sitting on a chair, in particular, a bed for allowing the posture for sitting on a chair to be taken, effectively usable even by those having the back in the shape of the round back, Kyphosis or the like.

In order to solve the problems described as above, the invention provides in its first aspect a bed for allowing a posture for sitting on a chair to be taken, said bed comprising a bed base, a fixed floor frame provided in an upper part of the bed base, a seat floor section shorter in length than the femoral region of a human body, a back rest floor section, and a leg floor section, wherein while one piece of mattress is placed over the seat floor section, and the back rest floor section, and one piece of mattress is placed over the leg floor section, the seat floor section, and the back rest floor section are able to cause the leg side part of the human body, and the head side part thereof, respectively, to be erected independently or in association with each other by use of a motor or, manually.

The back rest floor section and the seat floor section may be rendered slidably movable sideward of the bed base.

With those features, a head side portion of the back rest floor section, at a position corresponding to a height of the pelvis of the human body from an edge of the back rest floor section, adjacent to the seat floor section, is preferably rendered foldable so as to be erected toward the body through a suitable means, such as use of a motor, manually, and so forth, independently from an operation for erecting the back rest floor section.

With the bed for allowing the posture for sitting on a chair to be taken, according to the first aspect of the invention, the seat floor section, and the back rest floor section are able to cause the leg side part of the human body, and the head side part thereof, respectively, to be erected independently or in association with each other by use of the motor or, manually, and when the back of a user is raised, it is possible to erect the seat floor section according to personal difference to thereby lift up the knees of the user to an adequate position, so that the hamstrings at the back of knees has slack thereby setting the knees free.

Further, with the use of the seat floor section shorter in length than the femoral region, the knees are set free. And if the seat floor section is raised in such a state, the feet is pulled by the knees according to lifting of the knees, but without contraction occurring to the hamstrings at the back of knees, shifting of the upper half of the body toward the lower part of the body does not occur as experienced in the past. Further, as the seat floor section is in as-erected state, the body weight shifts toward the buttocks, thereby stabilizing a seating position. Accordingly, emergence of clearance, in the neighborhood of the back rest floor section, the seat floor section, and the axle of the bed, respectively, can be prevented, and when the back rest floor section is erected, it is possible to transfer the weight of the upper half of the body from the spine to the pelvis as tiled, thereby taking a stable seating position, and causing the body weight to rest on the tuber of ischium.

With the bed for allowing the posture for sitting on a chair to be taken, having some of those features described as above, the back rest floor section and the seat floor section can be rendered slidably movable sideward of the bed base, respectively, so that it is possible to slide the user on the bed, in the posture for sitting on a chair, to thereby enable the user to take the posture for sitting on a chair, with the back rest floor section, and the seat floor section, in as-erected state, respectively, outside the bed proper, by erecting the back rest floor section, and turning down the seat floor section, so that the user can drop the legs on the floor.

Furthermore, with the adoption of a configuration whereby the head side portion of the back rest floor section, at the position corresponding to the height of the pelvis of the human body from the edge of the back rest floor section, adjacent to the seat floor section, is rendered foldable so as to be erected toward the body through the suitable means, such as use of the motor, manually, and so forth, independently from the operation for erecting the back rest floor section, it is possible to prevent the emergence of the clearance, in the neighborhood of the back rest floor section, the seat floor section, and the axle of the bed, respectively, by aligning with the tilt of the pelvis even in the case of the bed being in use by those having the back in the shape of the round back, Kyphosis or the like. Further, because an angle formed between the spine and the pelvis can be properly kept, it is possible to transfer the weight of the upper half of the body from the spine to the pelvis as tiled, thereby taking the stable seating position, and causing the body weight to rest on the tuber of ischium. This will therefore prevent further tilting of the pelvis, thereby preventing further development in the round back.

### BRIEF DESCRIPTION OF THE DRAWINGS

FIG. 1 is a schematic illustration showing a human body and the hamstrings thereof, in a posture with the back in a prone position, and the legs extended forward;

FIG. 2 is a schematic illustration showing the biceps muscle of thigh, semitendinous muscle, and semimembraneous muscle with respect to the human body;

FIG. 3 is a schematic illustration showing the human body and the hamstrings thereof in a sitting posture with the legs thrown forward, and the back of the body tilted backward;

FIG. 4 is a schematic representation showing a patient with a round back;

FIG. 5 is a schematic representation showing a patient with Kyphosis;

FIG. 6 is a front view of a bed for allowing a posture for sitting on a chair to be taken, according to the invention;

FIG. 7 is a top plan view of the bed according to the invention, shown in FIG. 6;

FIG. 8 is a bottom view of the bed according to the invention, shown in FIG. 6;

FIG. 9 is a schematic illustration of an operation, showing a state of erecting a seat floor section of the bed;

FIG. 10 is a schematic illustration of an operation, showing a state of erecting a back rest floor section of the bed;

FIG. 11 is an enlarged schematic illustration showing an example of a tilted state retaining-member for use in erecting a head side frame of the back rest floor section;

FIG. 12 is a schematic side view showing an operation for erecting the head side frame of the back rest floor section;

FIG. 13 is a perspective view showing the bed according to the invention, in a slid state;

FIG. 14 is a schematic illustration showing an application example of the invention, out of which FIG. 14(a) is a schematic illustration showing a state where the seat floor section is erected, and FIG. 14(b) is a schematic illustration showing a state where the back rest floor section is erected, those figures being for use in explanation about ratios of weights of the respective parts of the human body in the supine posture to the body weight;

FIG. 15 is a schematic illustration showing an application example of the invention in the case of a patient with the back in the shape of the round back, Kyphosis or the like, out of which FIG. 15(a) is a schematic illustration showing a state where the head side frame is raised, FIG. 15(b) is a schematic illustration showing a state where the seat floor section is erected, and FIG. 15(c) is a schematic illustration showing a state where the back rest floor section is erected, those figures illustrating a state where the patient with the rounds back taking a posture for sitting on a chair, without mattress, on a sliding-type bed; and

FIG. 16 is a schematic illustration showing a state where the head side frame of the back rest floor section is being erected.

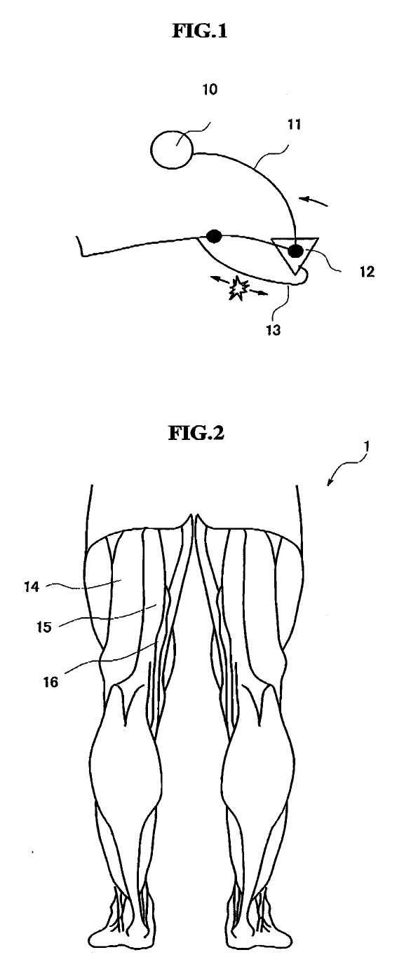

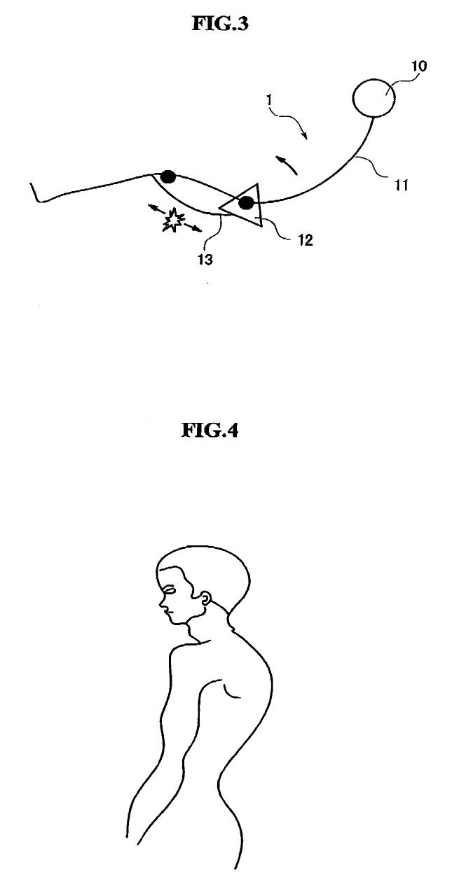

### DETAILED DESCRIPTION OF THE PREFERRED EMBODIMENTS

One embodiment of the invention is described hereinafter with reference to the accompanying drawings. It is to be pointed out, however, that the invention is not limited to the present embodiment of the invention.

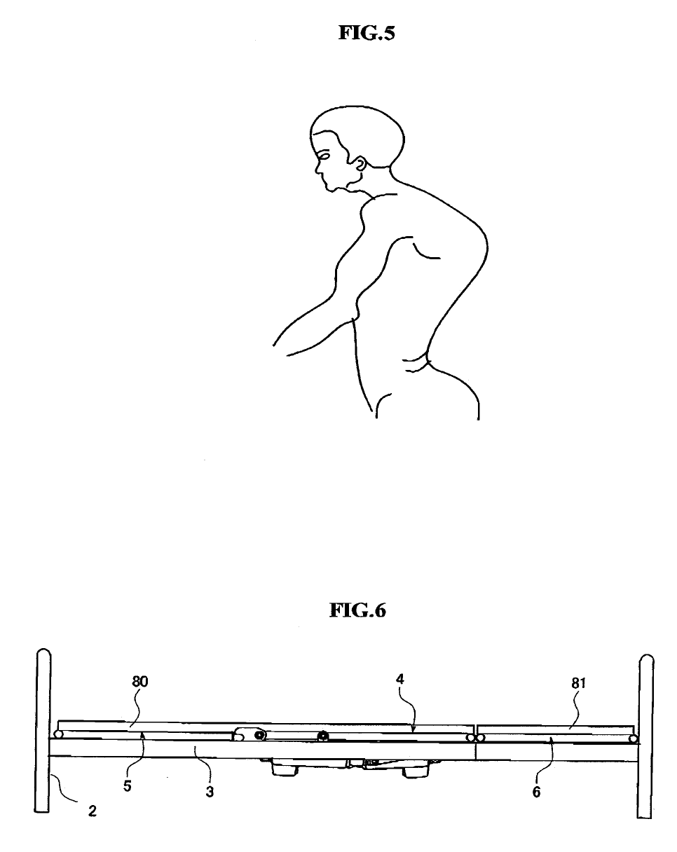

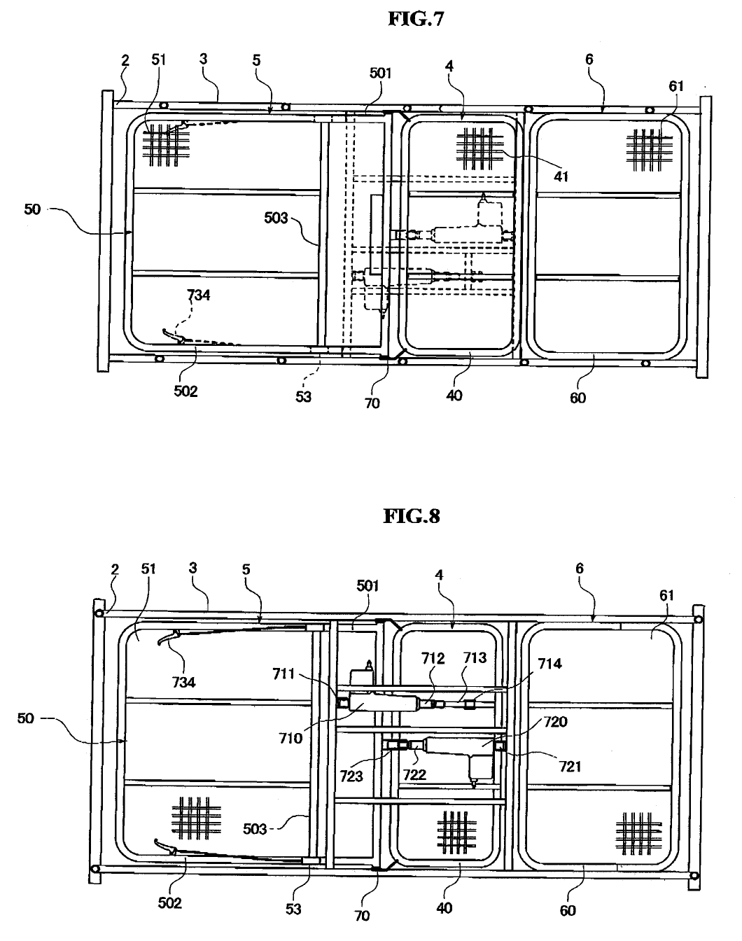

FIGS. 6 to 8 each are a schematic illustration showing the present embodiment of the invention, out of which FIG. 6 is a front view of a bed for allowing a posture for sitting on a chair to be taken, according to the invention, FIG. 7 is a top plan view thereof, and FIG. 8 is a bottom view thereof.

The bed according to the invention comprises a bed base 2, a fixed floor frame 3 provided in an upper part of the bed base 2, a seat floor section 4, a back rest floor section 5, and a leg floor section 6, as broadly classified, and one piece of mattress 80 is placed over the seat floor section 4, and the back rest floor section 5 while one piece of mattress 81 is placed over the leg floor section 6.

(the bed base 2 and the fixed floor frame 3)

The bed base 2 and the fixed floor frame 3 each are basically formed of suitable materials such as pipes, angles, and so forth, made of steel or the like, similar in strength to those making up a common bed of this type.

To give a specific example of a mechanism, use can be made of a mechanism of the same configuration as that described, for example, in U.S. Pat. No. 6,907,625 previously disclosed.

(the seat floor section 4, the back rest floor section 5, and the leg floor section 6)

As shown in FIGS. 6, 7, materials relatively high in strength, such as steel, and so forth, are used for the seat floor section 4, the back rest floor section 5, and the leg floor section 6, which are formed by use of square frames 40, 50 and 60, respectively. Nets, 41, 51 and 61, formed of a suitable material, such as steel, fiber, and so forth, are stuck to the square frames 40, 50 and 60, respectively.

The seat floor section 4 is formed such that length thereof, in the longitudinal direction of the bed, is shorter than that of the femoral region of a user. More specifically, if the user is a Japanese, the femoral region is 40 cm long, so that the seat floor section 4 is preferably formed to have a length on the order of 35 cm. With the adoption of such a length, the seat floor section 4 is rendered shorter in length than the femoral region, so that when the seat floor section 4 is raised, bending portions of the knees are freed, thereby providing the hamstrings with slack.

With respect to the seat floor section 4, and the back rest floor section 5, the seat floor section 4 swingably supports the leg side part of a human body and the back rest floor section 5 swingably supports the head side part of the body, respectively, so as to be independently erectable through the intermediary of a swingably support axle 70 provided in the fixed floor frame 3.

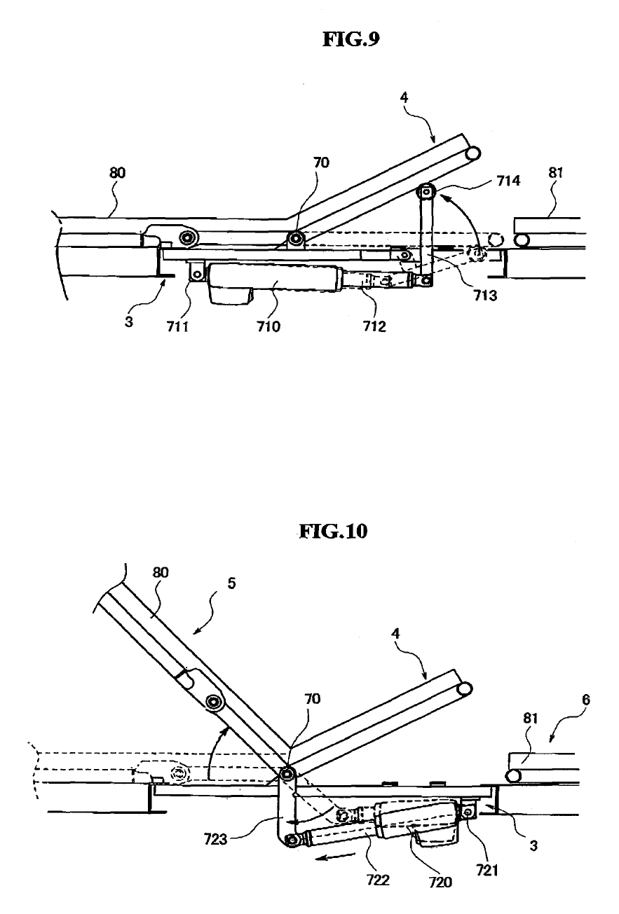

A configuration for causing the seat floor section 4, and the back rest floor section 5 to be erected is made up with a suitable configuration for operation by use of a motor, oil hydraulics, manually, and so forth. FIG. 9 is a schematic illustration showing an example of the configuration for causing the seat floor section 4 to be erected. A seat floor section drive actuator 710 for erecting the seat floor section 4 has a base end 711 that is swingably supported by the fixed floor frame 3, and a cylinder rod 712 at the tip of the seat floor section drive actuator 710 is swingably supported by one end of a T-shaped movable piece 713. The T-shaped movable piece 713 has a base end swingably supported by the fixed floor frame 3, and the other end of the T-shaped movable piece 713 is provided with a rotatably reciprocating roller 714 that is butted against the underside of the seat floor section 4. When the seat floor section drive actuator 710 is driven, the cylinder rod 712 is extended so as to change its posture from a state indicated by a dotted line in FIG. 9 to a state indicated by a solid line in FIG. 9, whereupon the T-shaped movable piece 713 is rotatably reciprocated, and a position where the rotatably reciprocating roller 714 provided at the other end of the T-shaped movable piece 713 is butted against the seat floor section 4 is shifted toward the swingably support axle 70, thereby causing the seat floor section 4 to be erected.

Then, a configuration for causing the back rest floor section 5 to be erected is also made up with the suitable configuration for operation by use of the motor, oil hydraulics, manually, and so forth. FIG. 10 is a schematic illustration showing an example of the configuration for causing the back rest floor section 5 to be erected.

A back rest floor section drive actuator 720 for erecting the back rest floor section 5 has a base end 721 that is swingably supported by the fixed floor frame 3, and a cylinder rod 722 at the tip of the back rest floor section drive actuator 720 is swingably supported by one end of a movable piece 723. The other end of the movable piece 723 is fixedly attached to the back rest floor section 5. When the back rest floor section drive actuator 720 is driven, the cylinder rod 722 is extended so as to change its posture from a state indicated by a dotted line in FIG. 10 to a state indicated by a solid line in the same figure, whereupon the movable piece 723 changes its angle. At this point in time, the back rest floor section 5 is swingably supported by the swingably support axle 70, so that the back rest floor section 5 is erected only to an extent of displacement of the movable piece 723.

Further, as shown in FIGS. 7, and 8, the frame 50 of the back rest floor section 5 is divided into two portions, namely, a waist side frame 501 and a head side frame 502, at a position corresponding to a height of the pelvis of the human body from an edge of the frame 50, adjacent to the seat floor section 4, and a waist upper end reinforcement 503 is formed at a site of division. Further, the frame 50 is configured such that a tip part thereof is rendered erectable by means of a tilted state retaining-member 73 provided in a tilted state retaining-member container 52 installed at respective ends of the waist upper end reinforcement 503.

In this case, the tilted state retaining-member 73 is formed so as to be, for example, of a ratchet structure as shown in FIG. 11, or the like.

FIG. 11 shows an example of the ratchet structure. A ratchet gear 730 of the tilted state retaining-member 73 in the tilted state retaining-member container 52 installed at the respective ends of the waist upper end reinforcement 503 is fixedly attached to an upper end on both sides of the waist side frame 501 of the frame 50.

Further, a retainer 731 with a front end meshing with the ratchet gear 730 is provided with a slidable jut 732 on both sides thereof, the slidable jut 732 being movable inside a window 520 provided in a flank of the tilted state retaining-member container 52, so that the retainer 731 as a whole is retractable against the ratchet gear 730. Aback end of the retainer 731 is provided with a front end of a work wire 733.

A back end of the work wire 733 is connected with a handle 734 provided in the waist upper end reinforcement 503, and when the handle 734 is gripped, the work wire 733 is moved so as to be drawn through a protection tube 735, so that meshing of the retainer 731 with the ratchet gear 730 can be disengaged. In the same figure, reference numeral 736 denotes a return spring provided between the retainer 731 and the tilted state retaining-member container 52, and when gripping of the handle 734 is released, the front end of the retainer 731 comes to mesh with the ratchet gear 730.

Further, the tilted state retaining-member container 52 in whole is provided at both the ends of the waist upper end reinforcement 503 so as to be rotatably reciprocating, and the head side frame 502 has a lower end fixedly attached to an upper end of the tilted state retaining-member container 52.

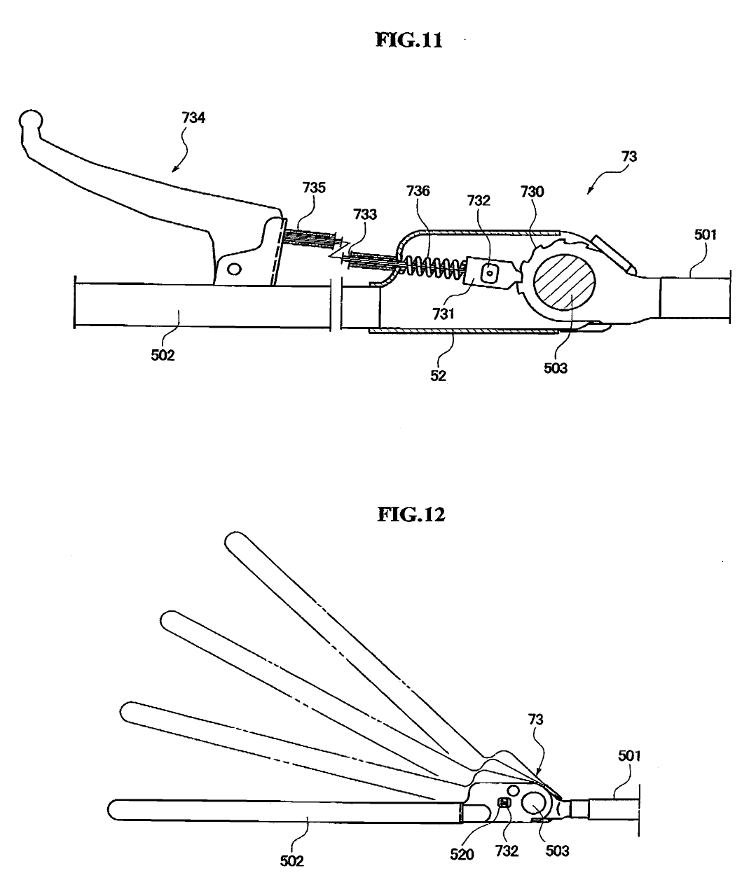

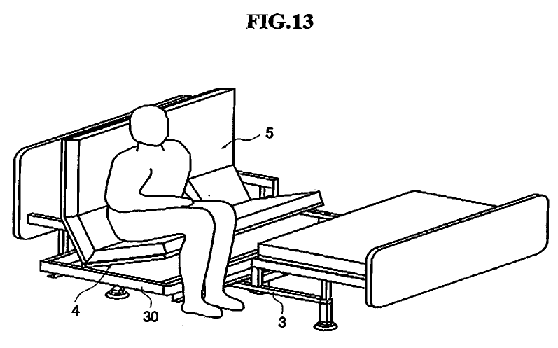

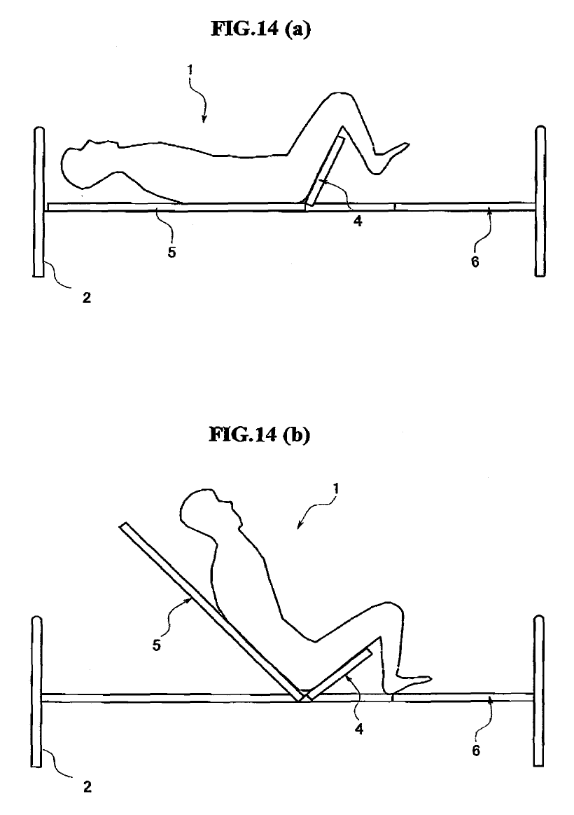

Accordingly, in the case of raising the head side frame 502 upward, a meshing position of the retainer 731 meshing with the ratchet gear 730 is changed, so that it is possible to erect the head side frame 502 as shown in FIG. 12.

Further, if a weight of the back can be fully held when the frame 50 of the back rest floor section 5 is tiled, the tilted state retaining-member 73 is not limited to the ratchet structure. Furthermore, with the invention, a mechanism of the head side frame 502, and the tilted state retaining-member 73 is preferably provided at a position where an angle of a round back curve is large. By so doing, it is possible to prevent the spine from sinking at least at the position, so that development in round back, and so forth can be stopped.

The seat floor section 4, and the back rest floor section 5 can be pulled out of the fixed floor frame 3 sideward by use of a movable floor frame 30, as shown in FIG. 13. For such a configuration, use can be made of the technology described in U.S. Pat. No. 6,907,625, as previously proposed by the inventor.

Now, there is described hereinafter an application example of the invention in the case of a common patient, and so forth.

First, the seat floor section drive actuator 710 is actuated to thereby erect the seat floor section 4 as shown in FIG. 14(a). At this point in time, the legs of the human body 10 are lifted, and a weight of the feet is supported by the seat floor section 4, the back rest floor section 5 through the intermediary of the pelvis of the human body 10, and the leg floor section 6 when the feet is in contact with the leg floor section 6. At this point in time, the hamstrings of the legs will be in as-slackened state.

It is important that the tuber of ischium at the extremity of the pelvis be positioned at the boundary between the back rest floor section 5, and the seat floor section 4 at the time of application, however, there can be cases where when the patient, and so forth are in a supine posture during asleep, the waist is in such a state as slipped toward the legs, and in the case of frail people at advanced ages, and so forth, crawling on their knees is not possible. Assuming that coefficient of static friction on the bed is 05, when the seat floor section 4 is erected not less 30°, a ratio of the buttocks to the body weight is 44%, and a ratio of the legs in whole to the body weight is 16%, together accounting for 60% of the body weight, so that either the waist naturally sinks, or the tuber of ischium can be positioned at the boundary between the back rest floor section 5, and the seat floor section 4 by use of a little force applied by a caregiver.

Next, the back rest floor section drive actuator 720 is actuated to thereby erect the back rest floor section 5 as shown in FIG. 14(b). With the legs in as-bent state, the hamstrings 13 has slack, so that no bending occurs to the knees, and therefore, pulling of the pelvis, toward the legs, caused by bending of the knees, as in the past, does not occur. Further, since the seat floor section 4 is in as-erected state, the body weight shifts toward the buttocks, thereby stabilizing a seating position, and setting the knees free. Furthermore, since the calf is away from the floor of the bed, it is possible to minimize effects on the hamstrings even if the heels of the feet are butted against the bed, so that a position of the trunk can be kept constant to thereby preemptively prevent degeneration of the spine of the patient. In addition, as the knees are set free, an improvement is achieved in that the contracture of the knees is prevented.

Subsequently, there is described hereinafter an application example of the invention in the case of a patient with the back in the shape of the round back, Kyphosis or the like.

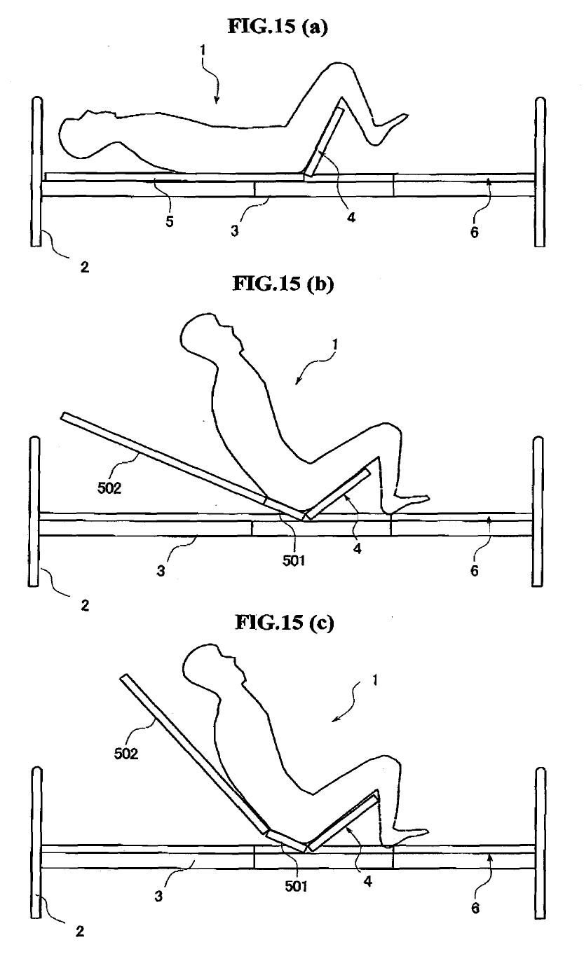

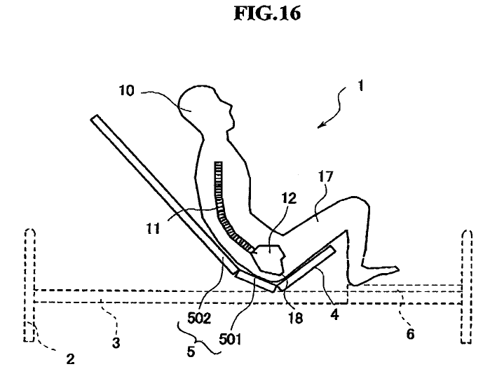

As above-described with reference to the application example of the invention in the case of the common patient, and so forth, an operation for erecting the seat floor section 4 (FIG. 15(a)) is first executed to be followed by an operation for erecting the back rest floor section 5 (FIG. 15(b)). Then, as shown in FIG. 15(c), the head side frame 502 is raised by the tilted state retaining-member 73 such that a present angle formed between the pelvis and the spine is kept, thereby completing the posture for the patient sitting on a chair, as shown in FIG. 16.

Further, an operation for raising the head side frame 502, whereby the angle between the pelvis and the spine is adjusted, may be executed prior to the operation for erecting the seat floor section 4.

Thus, with the invention, those whose bones, muscles, and so forth have declined in flexibility and so forth, such as the elderly having a body different from the standard human body, can take the posture for sitting on a chair with the hamstrings in as-slackened state. Further, since the knees are set free with the seat floor section 4 in as-erected state, force to pull up the buttocks is non-existent, and the buttocks come to rest at a predetermined position due to the body weight resting at the seat floor section 4, so that the pelvis is stabilized in such a state as pressed-down to the seat floor section 4, and the back rest floor section 5, and is prevented from tilting backward. In consequence, a portion of the weight of the upper half of the body is supported by the back rest floor section 5, but the most of the body weight is supported by the tuber of ischium 18 over the seat floor section 4 through the intermediary of a bonded part between the spine 11 and the pelvis 12.

Furthermore, if the pelvis 12 is kept in stable state over the seat floor section 4, and the back rest floor section 5, and a bending angle at the bonded part between the spine 11 and the pelvis 12 is adjusted so as to be slightly greater by erecting the head side frame 502 of the back rest floor section 5 through an adequate angle, this will put this region in a sort of stretched condition, thereby contributing to amelioration in the round back.

What is claimed is:

1. A bed for allowing a posture for sitting on a chair to be taken, said bed comprising a bed base, a fixed floor frame provided in an upper part of the bed base, a seat floor section shorter in length than the femoral region of a human body, a back rest floor section, and a leg floor section, wherein while one piece of mattress is placed over the seat floor section, and the back rest floor section, and one piece of mattress is placed over the leg floor section, the seat floor section, and the back rest floor section are able to cause the leg side part of the human body, and the head side part thereof, respectively, to be erected independently or in association with each other by use of a motor, manually, and so forth,

2. The bed according to claim 1, wherein the back rest floor section and the seat floor section is rendered slidably movable sideward of the bed base.

3. The bed according to claim 1, wherein a head side portion of the back rest floor section, at a position corresponding to a height of the pelvis of the human body from an edge of the back rest floor section, adjacent to the seat floor section, is rendered foldable so as to be erected toward the body through a suitable means, such as use of a motor, manually, and so forth, independently from an operation for erecting the back rest floor section.

4. The bed according to claim 2, wherein a head side portion of the back rest floor section, at a position corresponding to a height of the pelvis of the human body from an edge of the back rest floor section, adjacent to the seat floor section, is rendered foldable so as to be erected toward the body through a suitable means, such as use of a motor, manually, and so forth, independently from an operation for erecting the back rest floor section.
